(19) United States
(12) Patent Application Publication
(10) Pub. No.: US 2019/0080458 A1
(43) Pub. Date: Mar. 14, 2019

(54) INTERACTIVE OBSERVATION DEVICE

(71) Applicant: Shenzhen Sky View Technology Co., Ltd. & Al Technology Co., Ltd., Guangdong (CN)

(72) Inventor: Xia Wu, Guangdong (CN)

(21) Appl. No.: 15/700,440

(22) Filed: Sep. 11, 2017

(51) Int. Cl. G06T 7/20; H04N 5/225; H04N 7/04; G06T 11/00

(52) U.S. Cl. CPC G06T 7/20; G06T 11/001; H04N 7/04; H04N 5/2251

(57) ABSTRACT

An interactive observation device uses two display screens, positioned on a head-shaped housing where eyes would be located, to display animated eyes, while a video camera coupled with a 210-degree fisheye lens is positioned on the head-shaped housing in a nose position. The interactive observation device adjusts the appearance of the eyes displayed on the display screens based on the location of a person or object detected in one or more images captured by the video camera. Video captured by the video camera may be recorded and/or streamed to a remote mobile device for observation of a person or object by a user of the mobile device.

### FIELD OF THE DISCLOSURE

The present disclosure relates to observation devices, and more particularly to an interactive observation device.

### BACKGROUND

Observation devices are commonly used to maintain visual observation of a room or space in which the observer is not physically present. For example, a homeowner may use one or more surveillance cameras to monitor the security of a home while the homeowner is traveling. As another example, a parent or babysitter may utilize a “nanny cam” to enable visual observation of a child without the parent having to actually enter the room and risk waking up or otherwise distracting the child.

Traditional observation devices are designed only to capture an image and relay the image to a remote location. Most nanny cams, for example, comprise little more than a camera inside a housing together with an interface for transmission of captured images. Known nanny cams and similar observation devices are visually disinteresting and lack functionality for interacting with or entertaining an observed subject.

### SUMMARY

The present disclosure describes an observation device configured to interact with its environment, including with a person being observed. The observation device comprises a camera for capturing video and/or still images, and at least one screen for displaying graphics or other information. The observation device may also comprise one or more sensors for detecting one or more characteristics of the observation device's environment.

According to one embodiment of the present disclosure, an interactive observation device comprises a semi-ellipsoidal housing. The housing comprises: a plurality of screens on or near an outer surface of the housing; a video camera comprising a 210-degree fisheye lens; a microphone; a speaker; a wireless transceiver; a processor; and a memory. The memory stores instructions for execution by the processor that, when executed by the processor, cause the processor to identify, within an image captured by the video camera, a person or object; determine coordinates of the person or object in the captured image; modify an eye image stored in the memory based on the coordinates; and cause the modified eye image to be displayed on at least one of the plurality of screens.

The interactive observation device may further comprise at least one of a light sensor, a motion sensor, and a proximity sensor. The memory may store additional instructions for execution by the processor that, when executed by the processor, cause the processor to further modify the eye image based on information received from the at least one of the light sensor, the motion sensor, and the proximity sensor. The interactive observation device may further comprise a touch sensor that allows the processor to determine when the housing is being touched and to distinguish between a first type of touch and a second type of touch. The first type of touch may be tapping and the second type of touch may be petting. The memory may further store a plurality of sounds, and the memory may also store additional instructions for execution by the processor that, when executed by the processor, cause the processor to play one of the plurality of sounds via the speaker based on information received from one of the microphone and the video camera.

The memory may store additional instructions for execution by the processor that, when executed by the processor, cause the processor to stream a live video feed from the video camera via the wireless transceiver. The live video feed may be compressed using an H.265 video compression standard. The memory may store additional instructions for execution by the processor that, when executed by the processor, cause the processor to receive an audio signal via the wireless transceiver; and play the audio signal using the speaker. The memory may store additional instructions for execution by the processor that, when executed by the processor, cause the processor to adjust a color of the eye image based on user input. The semi-ellipsoidal housing may represent a head of a living creature having two eye positions and one nose position. One of the plurality of screens may be positioned at a first of the two eye positions, another of the plurality of screens may be positioned at a second of the two eye positions, and the video camera may be positioned at the one nose position. The living creature may be one of an owl, a rabbit, a cat, a dog, a bear, a tiger, a mouse, or a monkey.

According to another embodiment of the present disclosure, an interactive observation system comprises an interactive observation device comprising: a head-shaped housing having two eye positions and one nose position; two screens, each positioned at one of the two eye positions; a video camera comprising a 210-degree fisheye lens, the video camera positioned at the one nose position; a first wireless transceiver; a first processor; and a first memory. The first memory stores a plurality of eye images for display on the two screens, and further stores instructions for execution by the first processor that, when executed by the first processor, cause the first processor to: receive a transmit command via the wireless transceiver; and transmit a live video feed originated by the video camera via the wireless transceiver in response to the transmit command.

The interactive observation system may further comprise a mobile device comprising a second wireless transceiver, a second processor, and a second memory. The second memory stores a mobile app comprising instructions for execution by the second processor that, when executed by the second processor, cause the second processor to send a transmit command to the interactive observation device via the second wireless transceiver; and receive a live video feed from the interactive observation device via the second wireless transceiver.

The interactive observation device may further comprise a first microphone and a first speaker mounted within the housing. The mobile device may further comprise a second microphone and a second speaker. The first memory may store additional instructions for execution by the first processor that, when executed by the first processor, cause the first processor to receive a first audio signal generated by the first microphone; transmit the first audio signal, via the first wireless transceiver, to the mobile device; receive, via the first wireless transceiver, a second audio signal generated by the second microphone; and route the second audio signal to the first speaker.

The mobile app may further comprise instructions for execution by the second processor that, when executed by the second processor, cause the second processor to receive user input regarding a setting of the interactive observation device; generate a command based on the user input; and transmit the command, via the second wireless transceiver, to the interactive observation device. The interactive observation device may further comprise at least one of a motion sensor, a proximity sensor, and a touch sensor. The first memory may store additional instructions for execution by the first processor that, when executed by the first processor, cause the first processor to receive data from the at least one of the motion sensor, the proximity sensor, and the touch sensor; analyze the data; select an eye image from among the plurality of eye images to be displayed on each of the two screens; and cause the selected eye images to be displayed on the two screens. Each of the two screens may comprise an LCD screen.

According to yet another embodiment of the present disclosure, an interactive device for remote observation may comprise a housing; two display screens for displaying eye animations; a video camera comprising a 210-degree fisheye lens that is mounted on the housing equidistant from each of the two display screens; a microphone; a sensor; a wireless communication device; a processor; and a memory. The memory stores instructions for execution by the processor that, when executed by the processor, cause the processor to: receive a first input from one of the video camera, the microphone, and the sensor; based on the first input, cause a first eye animation to be displayed on the two display screens; receive a second input from one of the video camera, the microphone, and the sensor; and based on the second input, cause a second eye animation to be displayed on the two display screens.

The second eye animation may comprise a modified first eye animation. The memory may store further instructions for execution by the processor that, when executed by the processor, cause the processor to transmit one of a live video feed from the video camera and a live audio feed from the microphone via the wireless communication device.

The terms “memory” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A depicts a front elevational view of an interactive observation device according to one embodiment of the present disclosure;

FIG. 1B depicts a top plan view of the interactive observation device of FIG. 1A;

FIG. 1C depicts a bottom plan view of the interactive observation device of FIG. 1A;

FIG. 1D depicts a left side elevational view of the interactive observation device of FIG. 1A;

FIG. 1E depicts a right side elevational view of the interactive observation device of FIG. 1A;

FIG. 1F depicts a back elevational view of the interactive observation device of FIG. 1A;

FIG. 2 depicts an exploded view of an interactive observation device according to one embodiment of the present disclosure;

FIG. 3 is a block diagram of an interactive observation device according to another embodiment of the present disclosure;

FIG. 4 is a diagram of an interactive observation system according to yet another embodiment of the present disclosure;

FIG. 5 is a block diagram of a mobile application according to another embodiment of the present disclosure;

FIG. 6A is a front elevational view of an interactive observation device according to still another embodiment of the present disclosure, in a first configuration;

FIG. 6B is a front elevational view of the interactive observation device of FIG. 6A, in a second configuration;

FIG. 6C is a front elevational view of the interactive observation device of FIG. 6A, in a third configuration;

FIG. 6D is a front elevational view of the interactive observation device of FIG. 6A, in a fourth configuration;

FIG. 6E is a front elevational view of the interactive observation device of FIG. 6A, in a fifth configuration; and

FIG. 7 illustrates a coordinate system useful in some embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

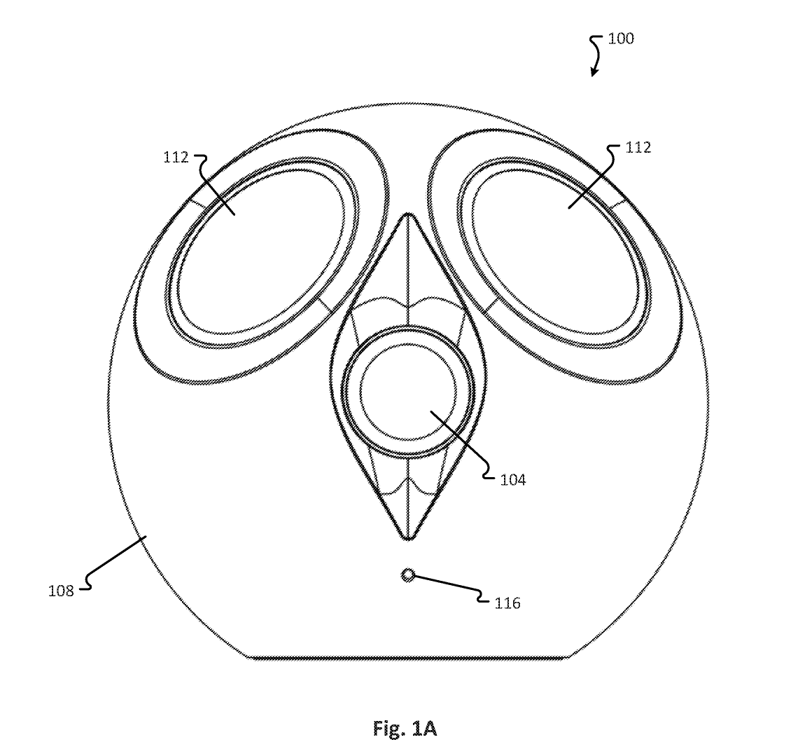

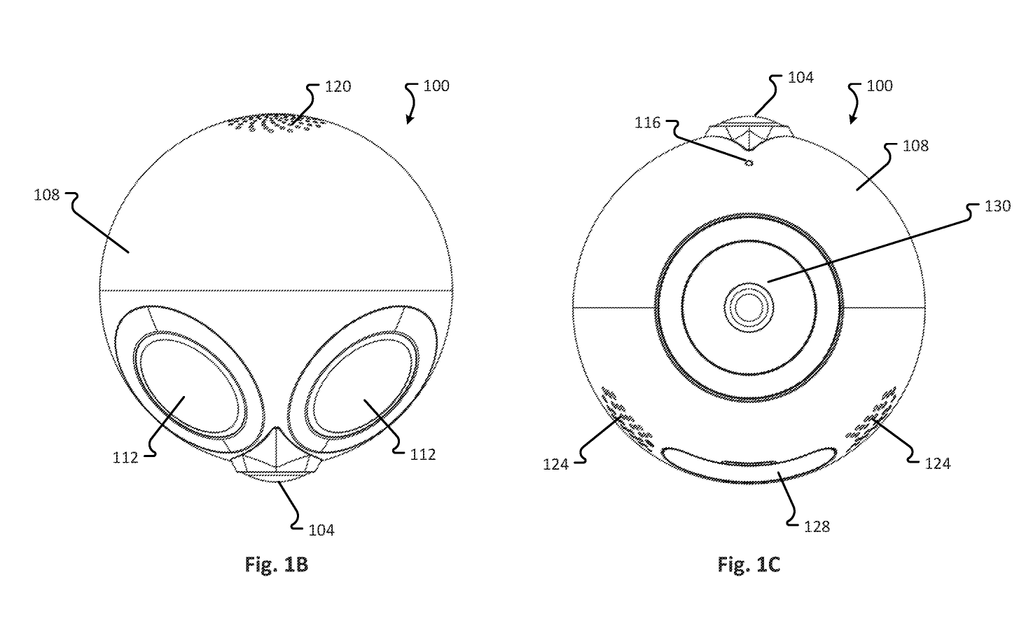

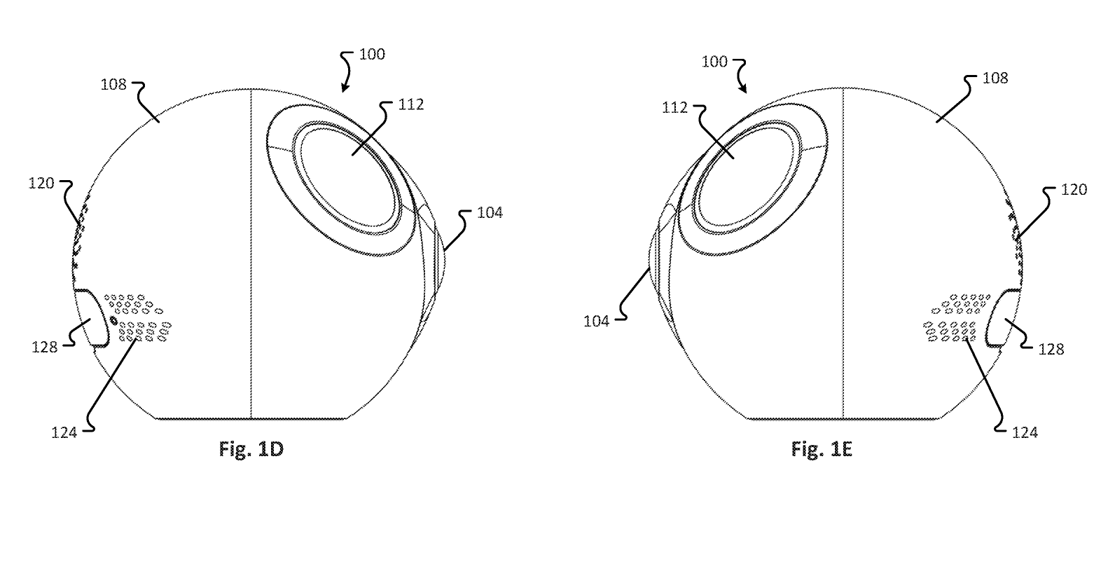

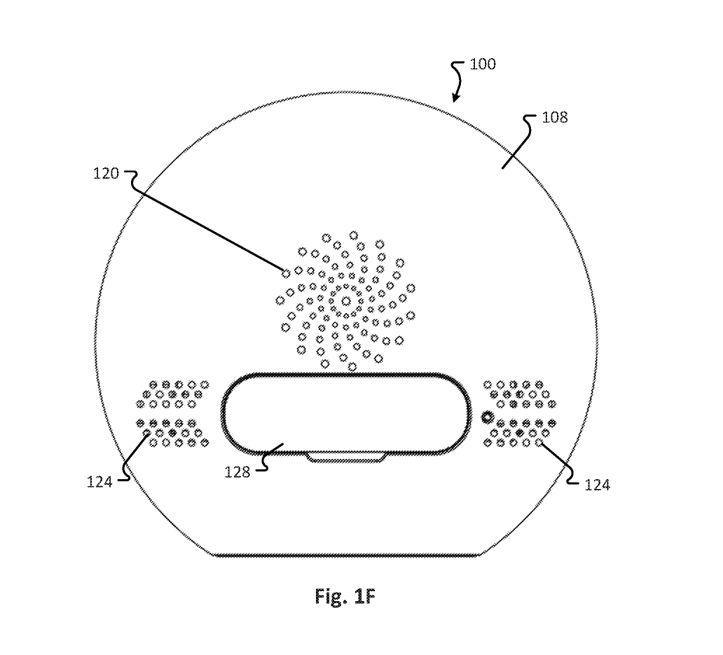

Turning to FIGS. 1A-1F, an interactive observation device 100 comprises a video camera 104 with a 210-degree fisheye lens, a semi-ellipsoidal head 108, a pair of LCD screens 112, and a microphone 116. The head 108 is shaped to represent a head of a living creature, such as an owl (although the head 108 may be shaped to represent the head of any other living creature, and the present disclosure is not limited to the use of heads 108 shaped to represent a head of a living creature). Other living creatures that could be represented by the head 108 include, for example, a rabbit, a cat, a dog, a bear, a tiger, a mouse, a dolphin, and a monkey. The LCD screens 112 are arranged on the head 108 in the position of eyes, and the video camera 104 is positioned on the head 108 so as to represent a nose or, in some embodiments, a beak. The microphone 116 may be positioned on the head 108 so as to represent another feature of a living creature, such as a mouth. Alternatively, the microphone 116 may be hidden from view or positioned on the head 108 without representing a feature of a living creature.

Positioned on the back side of the head 108 is a speaker mesh 120, a plurality of cooling holes or grids 124, and an access cover 128. The speaker mesh enhances the ability of sound waves created by the speaker 132 to pass through the head 108. The cooling holes or grids 124 facilitate air flow from inside to outside of the housing and vice versa, and thus help to keep the internal components of the interactive observation device 100 sufficiently cool. In some embodiments, the head 108 comprises a rotatable mount 130, which allows the head 108 to rotate. In some embodiments, the head 108 may be configured to rotate up to 360 degrees clockwise and/or counterclockwise. In other embodiments, the head 108 may be configured to rotate only 90 degrees in each direction (clockwise and counterclockwise). As persons of ordinary skill in the art will appreciate, given the 210-degree fisheye lens of the video camera 104, rotation of the head 108 by 90 degrees in the clockwise and counterclockwise directions would be sufficient to provide more than 360 degrees of visibility to the video camera 104. The rotatable mount 130 may comprise a motor so as to enable automatic rotation of the head 108, or the rotatable mount 130 may simply allow for manual rotation of the head 108.

In some embodiments, the head 108 may further comprise a third LCD screen in the position of a mouth. Also in some embodiments, the head 108 may contain a miniprojector, which may be configured to project images and/or video through a lens positioned on the head 108. Such a lens may or may not be positioned on the head 108 to represent a feature of a living creature. The lens may, in some embodiments, be positioned on the back of the head 108 (e.g. in the vicinity of the access cover 128) or on the top of the head 108.

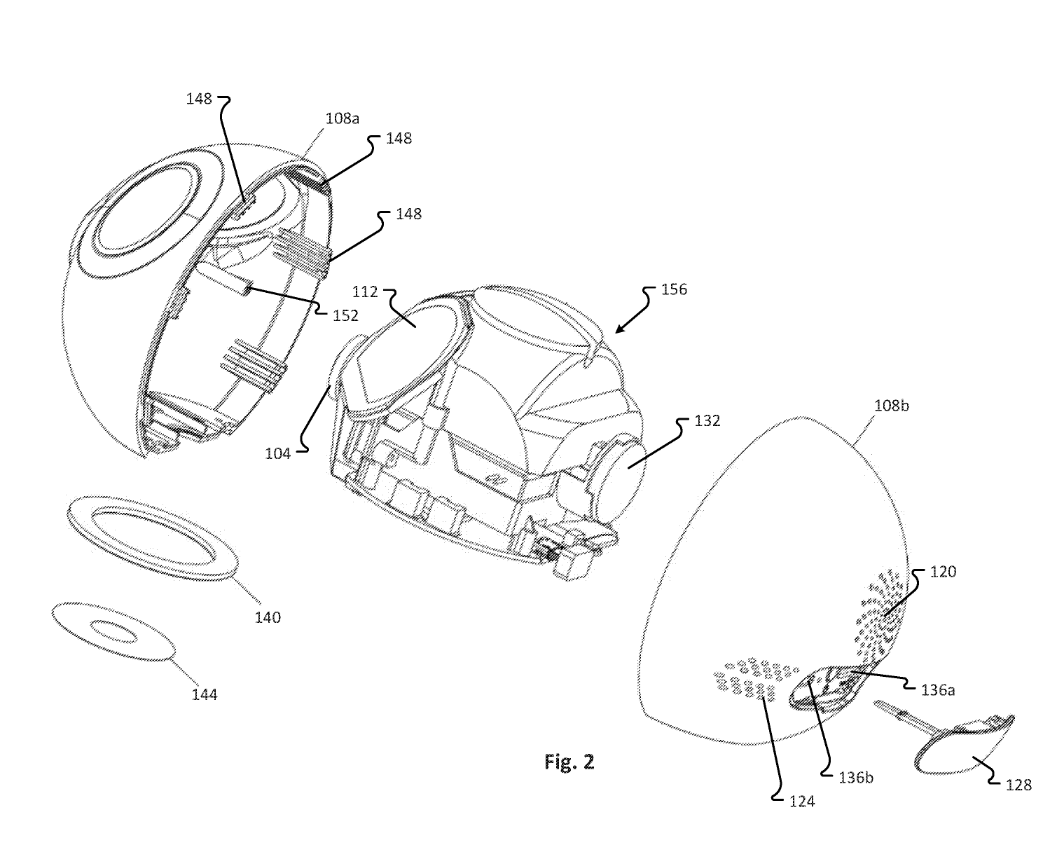

FIG. 2 shows an exploded view of an interactive observation device 100. As depicted in FIG. 2, the head 108 comprises a first half 108a and a second half 108b. The first half 108a is provided with a plurality of extensions 148 configured to snap onto the inner circumference of the second half 108b, so as to hold the halves 108a and 108b together.

The first and second halves 108a and 108b also comprise a plurality of interior features 152 configured to support the interior component package 156. Included in the interior component package 156 are video camera 104 with the 210-degree fisheye lens (which lens may protrude through an opening in the first half 108a when the head 108 is fully assembled), the pair of LCD screens 112, and a speaker 132. In some embodiments, the first half 108a comprises openings through which the LCD screens 112 are visible when the head 108 is fully assembled, while in other embodiments the first half 108a comprises glass or plastic windows that protect the LCD screens 112 while still allow the screens 112 to be visible. Also shown in FIG. 2 are ports 136a and 136b, which are normally concealed underneath the access cover 128. The ports 136a and 136b may be used, for example, to connect a power cord to the interactive observation device (whether to charge a battery thereof or as a primary power source); to connect another computing device to the interactive observation device 100 (e.g. to download recorded video from a memory of the interactive observation device 100, or to update software stored in the memory of the interactive observation device 100); or to connect one or more external microphones, speakers, cameras, or other sensors or equipment to the interactive observation device. Washers 140 and 144 facilitate the rotation of the head 108 around the rotatable mount 130.

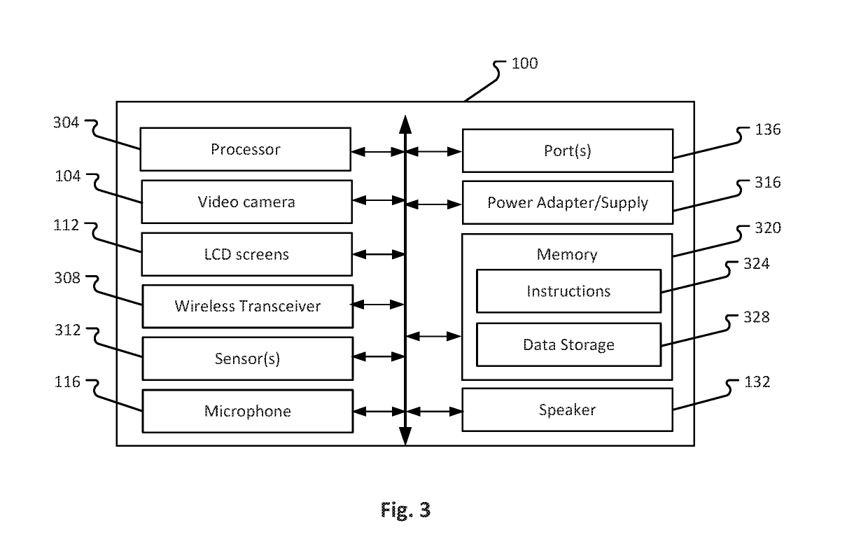

Turning now to FIG. 3, the interactive observation device 100 comprises—in addition to the video camera 104, the LCD screens 112, the microphone 116, the ports 136, and the speaker 132—a processor 304, a wireless transceiver 308, one or more sensors 312, a power adapter/supply 316, and a memory 320.

The processor 304 may correspond to one or multiple microprocessors that are contained within the head 108 of the interactive observation device 100. The processor 304 may comprise a Central Processing Unit (CPU) on a single Integrated Circuit (IC) or a few IC chips. The processor 304 may be a multipurpose, programmable device that accepts digital data as input, processes the digital data according to instructions stored in its internal memory, and provides results as output. The processor 304 may implement sequential digital logic, as it has internal memory. As with most known microprocessors, the processor 304 may operate on numbers and symbols represented in the binary numeral system. The processor 304 may execute instructions stored in a firmware thereof, and may also execute instructions stored in the memory 320. The processor 304 may be used to control one or more aspects of one or more of the video camera 104, the LCD screens 112, the wireless transceiver 308, the sensors 312, the microphone 116, the port(s) 136, the power adapter/supply 316, and the speaker 132. The processor 304 may also be used to read data from or to write data to the memory 320, and may be configured to execute instructions stored within the memory 320.

The video camera 104 is a digital video camera, and may use a CMOS image sensor or a CCD device to capture/record video. The video camera 104 may be a network-enabled camera, also referred to as a “webcam” or an “IP camera.” The video camera 104 is equipped with a 210-degree fisheye lens, which beneficially increases the field of view of the video camera 104. In some embodiments, the camera 104 may be equipped with a 180-degree fisheye lens, or with a fisheye lens having a field of view of anywhere between 100 and 300 degrees. In other embodiments, the camera 104 may be equipped with a normal (non-fisheye) lens having a field of view of between six degrees and 100 degrees. The video camera 104 may include a dedicated processor and/or memory, and may comprise various features known to those of skill in the art, including, for example, optical zoom, digital zoom, autofocus, vignetting, optical aberration correction, and optical image stabilization. These features may be provided as part of the video camera 104 itself (e.g. as a set of instructions stored in dedicated memory of the video camera 104, for execution by a dedicated processor of the video camera 104), in firmware 324 stored in the memory 320 and used to operate the video camera 104, or in any other set of instructions available to the processor 304 or to a dedicated video camera processor. The camera may be manufactured, for example and without limitation, by any one of Toshiba Corp., ST Microelectronics N.V., Sharp Corp., Omnivision Technologies, Inc., AXIS, and ON Semiconductor. In some embodiments, the video camera 104 may utilize the Sony STARVIS image sensor (also known as a starlight image sensor), or any other image sensor designed to capture full-color images in low light conditions.

The video camera 104, in some embodiments, is configured to record continuously, and to upload recorded video to the cloud via the wireless transceiver 308. In some embodiments, the recorded video may first be stored in the memory 320, and then uploaded to the cloud. Also in some embodiments, the interactive observation device 100 may allow a user to adjust a setting to control whether video is recorded continuously. In other embodiments, the interactive observation device 100 may be configured to record video only upon receipt of a command, which may occur, for example, when a switch on the exterior of the head 108 is flipped, or when an owner or operator of the interactive observation device 100 transmits a command from a mobile device 402.

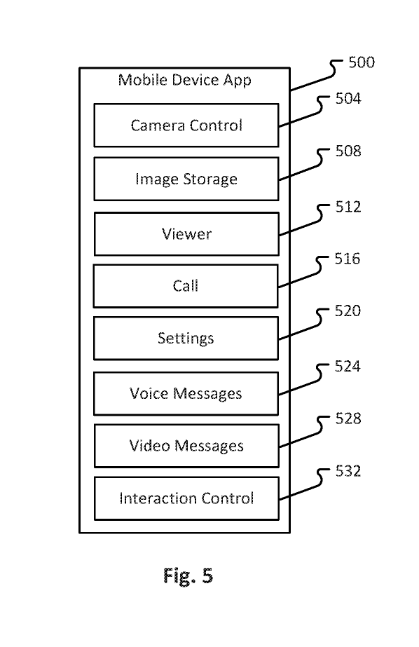

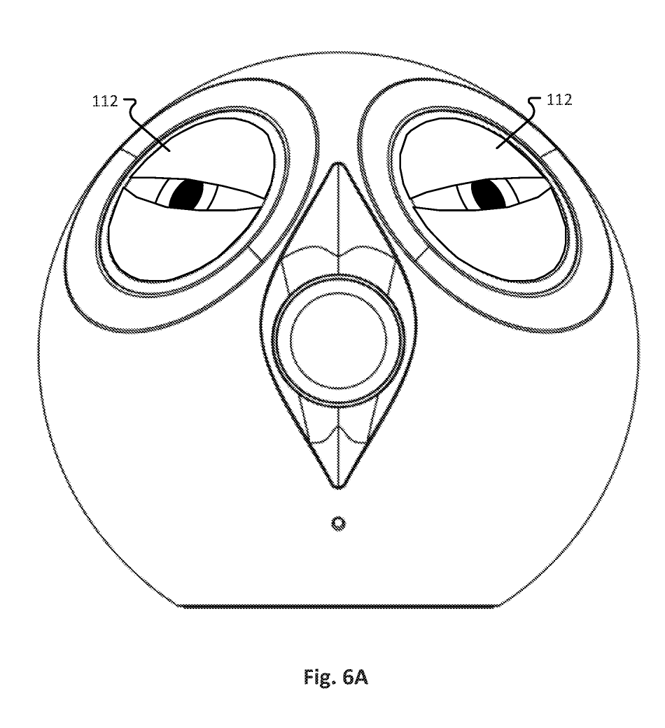

In some embodiments, the interactive observation device 100 may also be provided with at least one, if not a plurality, of LED lights. The LED lights may be configured to turn on automatically in low-light conditions (as detected, for example, by a light sensor included in the interactive observation device 100). The LED lights may also be configured to be turned on and off by a user, e.g. through a mobile app such as that described below in connection with FIG. 5. The LED lights may be configured to remain on for the duration of the low-light condition, or they may be configured to turn on for a given amount of time in response to certain triggers, such as detection of motion by a motion sensor of the interactive observation device 100. The LED lights, when included in the interactive observation device 100, may be configured only to increase the amount of light to a minimum level, rather than to provide a bright light that optimizes image capture. In some embodiments, the LED lights may be configured to emit light of a plurality of colors (e.g. of a plurality of wavelengths), which colors may or may not be selectable by a user or controller of the interactive observation device 100. In other embodiments, the LED lights may be configured to emit light of only one color (e.g. of only one wavelength).

Additionally, in some embodiments, the brightness of the LED lights may be manually controllable via a mobile app (described, again, in greater detail below in connection with FIG. 5). Thus, if a parent places the interactive observation device in a child's room to observe the child at night, and the child expresses a desire for light (or the parent needs to increase the amount of light to better view the room), the parent may utilize the mobile app to cause the LED lights to illuminate and/or to shine more brightly. Of course, the parent may also, in such embodiments, utilize the mobile app to cause the LED lights to turn off or to shine less brightly.

The LCD screens 112 may be used to display digital images, animations, video, text, and/or information to a user of the interactive observation device 100. The user may be a person who is being observed by the interactive observation device 100 (e.g. a child) or a person who is using the interactive observation device 100 to observe someone else (e.g. a parent). The screens 112, which may in other embodiments be an LED screen, an OLED screen, an AMOLED screen, a Super AMOLED screen, a TFT screen, an IPS screen, a TFT-LCD screen, or any other known variety of screen, may be touchscreens, and may be used to present virtual buttons or other controls to a user for setup of the interactive observation device 100. Such virtual buttons or controls may be useful, for example, for configuring settings of the interactive observation device 100, such as wireless communication settings, or for selecting one or more of a plurality of options regarding, for example, what will be displayed on the LCD screens 112, whether the interactive observation device 100 will play any sounds through the speaker 132 and, if so, which sounds; how long the interactive observation device 100 will remain active when it does not detect any motion; what the interactive observation device 100 will do when it detects motion; and so forth. In other embodiments, the interactive observation device 100 may not use the LCD screens 112 to assist in setup, which may be handled entirely through a mobile app such as that described below in connection with FIG. 5.

In some embodiments, the LCD screens 112 may be used to display digital images and/or animations of eyes, giving the interactive observation device 100 the appearance of being alive. The display provided by the LCD screens 112 may be customizable. For example, a user of the interactive observation device 100 may be able to select and/or change the color of the eyes displayed on the screens 112, the size of the eyes displayed on the screen 112, and other such features. Also in some embodiments, the interactive observation device 100 may comprise, in addition to one or more LCD screens 112 for displaying one or more digital images and/or animations of eyes, one or more LCD screens 112 for displaying one or more digital images of a mouth, and/or of another feature or object that might be found on the head of a living creature. Embodiments of the present disclosure are not, therefore, limited to two LCD screens 112, but may comprise three LCD screens 112, four LCD screens 112, or any other number equal or greater to one LCD screen 112.

The wireless transceiver 308 comprises hardware that allows the interactive observation device 100 to connect with a mobile device, such as a smartphone, tablet, or laptop, or with another computing or memory device equipped for wireless communications (or that is in wired communication with the Internet, if the interactive observation device 100 is equipped to communicate independently over the Internet). The wireless transceiver 308 may in some embodiments enable the interactive observation device 100 to stream a live video feed to a connected device, and may further enable the interactive observation device 100 to stream a live audio feed to a connected device. A video compression standard such as high efficiency video coding, also known as H.265 and MPEG-H Part 2, may be used to improve the transmission rate of video streamed via the wireless transceiver 308 and reduce bandwidth usage. Still further, the wireless transceiver 308 may enable the interactive observation device 100 to receive user input and/or commands from a mobile device, including to modify one or more settings of the interactive observation device 100, to cause the interactive observation device 100 to take a picture or to start or stop recording a video or transmitting a live video feed, or to capture a screenshot of a recorded video or live video feed; or otherwise to access or utilize one or more features of the interactive observation device 100.

The wireless transceiver or wireless communication device 308 may comprise one or more of a Bluetooth interface, a Wi-Fi card, a Network Interface Card (NIC), a cellular interface (e.g., antenna, filters, and associated circuitry), a near field communication (NFC) interface, a ZigBee interface, a FeliCa interface, a MiWi interface, a Bluetooth low energy (BLE) interface, or the like. Regardless of the protocol used by the wireless transceiver 308, the wireless transceiver 308 may comprise, for example, a transmitter, a receiver, and an antenna, and may also comprise software or firmware needed to operate such components.

The interactive observation device 100 also includes one or more sensors 312, including one or more of a motion sensor, a light sensor, a touch sensor, and a proximity sensor. In embodiments with a motion sensor, the interactive observation device 100 may awaken from a low-power state when motion is detected, and rotate its head 108 on the rotatable mount 130 so that the video camera 104 and the LCD screens 112 are pointed towards the detected motion. This both gives the appearance that the interactive observation device 100 is alive, and ensures that the person or object in motion is within the field of view of the video camera 104, so that someone who is using the interactive observation device 100 to observe a person or space can see the source of the motion. Further, a motion sensor can be used to allow the interactive observation device 100 to continuously track a person or object. Thus, for example, if the interactive observation device 100 is being used to observe a child, the head 108 of the interactive observation device 100 may rotate on the rotatable mount 130 so as to be continuously pointed at the child, based on the motion of the child as detected by the motion sensor. In some embodiments, in addition to or instead of rotating the head 108 around the rotatable mount 130, the interactive observation device 100 may simply cause eyes displayed on the LCD screens 112 thereof to pan across the screen, so as to give the appearance that the interactive observation device 100 is watching the source of the movement with its eyes. Such a display may be particularly appropriate when the motion is detected well within the field of view of the video camera 104, but still to one side of the central viewing axis of the interactive observation device 100. The motion sensor may be a standalone motion sensor (such as a passive infrared (PIR) sensor), or the motion sensor may be incorporated into the video camera 104 or another component of the interactive observation device 100. For example, some image sensors used for video cameras, particularly image sensors adapted to capture detailed images in low-light conditions, include a motion detection function.

In embodiments with a light sensor, the light sensor may be used to determine, for example, whether an observed space is light or dark, which information may be used to determine which of a plurality of behaviors the interactive observation device 100 exhibits. For example, if the room is light, then the interactive observation device 100 may be configured to remain in a powered, “awake” state, to play sounds more loudly, and to initiate interactions when motion is detected. When the room is dark, the interactive observation device 100 may be configured to enter a low-power “sleep” mode if no motion is detected within a predetermined period of time, to play sounds more quietly, and to transmit an alert or alarm via the wireless transceiver 308 if motion is detected. These are just some examples of possible behaviors based on the light/dark determination.

A light sensor may also be used to automatically adjust one or more settings of the video camera 104 to increase the video camera's ability to obtain properly exposed images, as well as to adjust the brightness of the LCD screens 112 so that they are not unnecessarily bright in a dark environment, but are bright enough to be seen in a light environment.

In some embodiments, the interactive observation device 100 may be provided with one or more touch sensors that can detect when the head 108 is being touched. Some such embodiments may further comprise one or more touch sensors that can distinguish between different types of touch, such as tapping and petting. In such embodiments, the interactive observation device 100 may be configured to respond to touch. For example, the interactive observation device 100 may be configured to awake out of a low-power state if it detects that the head 108 is being tapped. As another example, the interactive observation device 100 may be configured to play appropriate sounds (e.g. “hooting” if the head 108 is configured to represent an owl; “purring” or “meowing” if the head 108 is configured to represent a cat) when a touch sensor in the head 108 detects that the head 108 is being petted.

The interactive observation device 100 may additionally or alternatively comprise a proximity sensor. The proximity sensor may be used to determine whether a person or object is approaching the interactive observation device 100 or getting farther away from the interactive observation device 100, as well as whether a person or object is close to or far away from the interactive observation device 100. Such information may inform the behaviors of the interactive observation device 100. For example, the interactive observation device 100 may display squinting eyes on the LCD screens 112 thereof when a person or object of interest is far away, and may display wide open eyes on the LCD screens 112 thereof when a person or object of interest is near.

The interactive observation device 100 further comprises a microphone or other audio transducer 116. The microphone 116 may be useful, for example, to capture sound when recording a video or transmitting a live feed with the interactive observation device 100. Additionally, sounds captured by the microphone 116 may trigger certain behaviors of the interactive observation device 100. For example, when the microphone 116 detects crying, the interactive observation device 100 may be programmed to send an alert or alarm via the wireless transceiver 308. In some embodiments, the interactive observation device 100 may be provided with voice recognition capability (or may be configured to utilize voice recognition capability provided by another system or device), and may be configured to respond to spoken statements, inquiries, or commands. For example, if the microphone detects an audio command such as “record this,” then the interactive observation device 100 may either begin recording (if the interactive observation device 100 is not continuously recording) or simply mark the time of the command (if the interactive observation device 100 is continuously recording), and await a “stop recording” command. When the microphone detects a “stop recording” command, then the interactive observation device 100 may snip out a video clip that runs from the “record this” to the “stop recording” commands, and send or post the video clip (via the wireless transceiver 308, for example) to a predetermined location (e.g. an email address, a social media account).

In some embodiments, one or more microphones 116 may also be used as sensors for controlling one or both of rotation of the interactive observation device 100 around the rotatable mount 130, and movement of eyes displayed on the screens 112. For example, the interactive observation device 100 may be equipped with two microphones 116, which may be used to triangulate a location of a particular sound in relation to the interactive observation device 100. This information may be used by the processor 304 to cause eyes displayed on the LCD screens 112 to track a source of the noise. In some embodiments, a motion sensor may also be used to help identify the location of a source of a given sound or noise, so as to allow the processor to cause eyes displayed on the LCD screens 112 to more effectively track the source of the noise. The determined location information may also be used to cause the interactive observation device 100 to rotate around the rotatable mount 130, so that the source of the noise is within the field of view of the video camera 104 and/or so that the video camera 104 is pointed directly at the source of the noise.

The port(s) 136 may have one or more functions, including as a power port for connecting the interactive observation device 100 to an external power source (whether for powering normal operation of the interactive observation device 100 or for charging/recharging a battery of the interactive observation device 100), or for connecting a mobile device or an external storage device to the interactive observation device 100 (e.g. to download or otherwise offload pictures and/or videos from the interactive observation device 100, or for transmitting a live video or audio feed to the connected mobile device, or for gaining access to additional controls and/or settings for the interactive observation device 100 via the connected mobile device, or to enable the interactive observation device 100 to access the Internet through a wireless transceiver of the connected mobile device). In some embodiments, connection of a mobile device to the interactive observation device 100 via the port 136 allows the mobile device to be used to control the operation of the video camera 104 and/or of the other components of the interactive observation device 100. In still other embodiments, the port(s) 136 may be useful for connecting additional components to the interactive observation device 100 so as to improve the functionality thereof. Such additional components may include, for example, one or more additional processors, one or more additional sensors, one or more additional cameras, and computer-readable storage containing additional instructions for execution by the processor 304, so as to expand the feature set of the interactive observation device 100. The port(s) 136 may be one or more of a USB port, a Lightning port, a Firewire port, an Ethernet port, or any other port through which data and/or power may be transferred. Where the USB protocol is used, the port 136 may be one or more of Type A, Type B, Mini-A, Mini-B, Micro-A, and/or Micro-B ports.

The power adapter/supply 316 may comprise circuitry for receiving power from an external source and accomplishing any signal transformation, conversion or conditioning needed to provide an appropriate power signal to the processor 304, the video camera 104, and the other powered components of the interactive observation device 100. An external power source may be connected to the power adapter/supply 316 via a port 136 or via a dedicated power port of the power adapter/supply 316. Additionally or alternatively, the power adapter/supply 316 may comprise one or more batteries for supplying needed power to the interactive observation device 100. Such batteries may be used for normal operation, or such batteries may provide backup power (e.g. when power from an external source is not available). In embodiments comprising one or more batteries, the batteries may be removable and replaceable, and/or the batteries may be rechargeable. In embodiments with rechargeable batteries, the interactive observation device 100 may utilize a port 136 as a power inlet port, or the power adapter/supply 316 may comprise a dedicated charging port for recharging rechargeable batteries contained therein.

The memory 320 may comprise an instructions section 324 and a data storage section 328. The memory 320 may correspond to any type of non-transitory computer-readable medium. In some embodiments, the memory 320 may comprise volatile or non-volatile memory and a controller for the same. Non-limiting examples of memory 320 that may be utilized in the interactive observation device 100 include RAM, ROM, buffer memory, flash memory, solid-state memory, or variants thereof. The memory 320 may be accessible by the processor via, for example, a Serial Peripheral Interface bus.

The instructions section 324 may store any electronic data (including instructions for execution by the processor 304) needed for operation of the interactive observation device 100. For example, the memory 320 may store any firmware needed for allowing the processor 304 to operate and/or communicate with the various components of the interactive observation device 100, as needed, and to communicate with one or more mobile devices connected to the interactive observation device 100 via the wireless transceiver 308 or a port 136.

As another example, the instructions section 324 may store instructions that enable the interactive features of the interactive observation device 100. These instructions may include, for example, instructions for how to rotate the head 108 around the rotatable mount 130 in response to information received from one or more sensors 312 and/or from the video camera 104; instructions for recognizing, processing, and executing spoken commands received via the microphone 116; instructions for playing sounds (including, in some embodiments, speech generated by a local or remote speech generator) through the speaker 132; instructions for displaying images, animations, or other graphics or information on the LCD screens 112; instructions for operation of the video camera 104, including instructions for recording video captured by the video camera 104 and/or streaming video from the video camera 104 via the wireless transceiver 308; instructions for using face or voice recognition to identify persons within the field of view of the video camera 104 or within the range of the microphone 116; instructions for receiving and executing commands from an app operating on a mobile device or other remote computing device and received via the wireless transceiver 308 or through a wired connection to a port 136; and instructions for responding to any other information received from a sensor 312 beyond that described above (e.g. instructions for responding to information received from a touch sensor about the interactive observation device 100 being touched).

In some embodiments, the instructions section 324 may store instructions enabling Amazon.com, Inc.'s Alexa voice recognition technology to be used on the interactive observation device 100. Such instructions may, for example, cause audio signals (or other signals derived from audio signals) received from the microphone 116 to be transmitted over the Internet to one or more Amazon.com, Inc. servers (via, for example, the wireless transceiver 308), and may further cause audio signals (or other signals from which audio signals may be derived) to be received over the Internet from one or more Amazon.com, Inc. servers (via, for example, the wireless transceiver 308), and to be routed to the speaker 132 for playback. Additionally, such functionality may be triggered by the detection of the word “Alexa” is speech picked up by the microphone 116. Consequently, a person within speaking range of the interactive observation device 100 may say “Alexa” and then ask a question or speak a command. The instructions stored in the instructions section 324 may then cause the question or command to be sent via the wireless transceiver 308 to Amazon.com, Inc.'s servers, which may analyze the question or command and send back a response. Upon receipt of the response through the wireless transceiver 308, the processor 304 may send the response to the speaker 132 for playback.

Also in embodiments comprising instructions that enable Alexa functionality on the interactive observation device 100, the instructions section 324 may further comprise instructions configured to cause certain animations to play on one or more of the LCD screens 112 based upon responses received from Amazon.com, Inc.'s servers in response to a question or command directed to Alexa. For example, where the LCD screens 112 are used to display images or animations of eyes, the instructions section 324 may comprise instructions configured to cause the LCD screens 112 to display an animation of eye-rolling, eyebrow-raising, eyes widening, eyes narrowing, or eyes repeatedly looking back and forth, depending on a particular received response to a question or command directed to Alexa. Where an LCD screen 112 is used to display images or animations of a mouth, the instructions section 324 may comprise instructions configured to cause that LCD screen 112 to display an animation of one or more mouth movements corresponding to the received response to a question or command directed to Alexa. For example, the LCD screen 112 may be used to display mouth movements that correspond to response, so that it appears as if the interactive observation device 100 is speaking the received response.

The instructions section 324 may further comprise instructions configured to allow the interactive observation device 100 to convert text into speech. The interactive observation device 100 may receive text via the wireless transceiver 308 (e.g. from a mobile device 402), or may detect text through the video camera 104. Such text-to-speech instructions may be configured to cause the generated speech to have one or more unique qualities that cause the speech to have a particular “voice,” which may correspond to the living creature represented by the interactive observation device 100, or to a television character or other well-known personality. Also in some embodiments, such text-to-speech instructions may be configured to cause the generated speech to have one or more unique qualities that cause the generated speech to sound like an owner or operator of the interactive observation device 100. For example, where the interactive observation device 100 is used by a parent to monitor a child, the generated speech, when played over the speaker 132, may be configured to sound like the parent. The text used as the basis for speech may be stored in the data storage section 328, and/or may be received via the wireless transceiver 308.

The data storage section 328 may store any electronic data corresponding to, for example, videos recorded by the interactive observation device 100 and events logged by the interactive observation device 100 (e.g. motion detection events, detection of spoken commands received via the microphone 116, receipt of commands via the wireless transceiver 308). Such data may be regularly or intermittently downloaded or offloaded to a mobile device or external storage device (including a storage device in the cloud) connected to the interactive observation device 100 via the wireless transceiver 308 or a port 136, to ensure that the data storage section 328 maintains enough free space within the memory 320 to store newly captured photos or videos.

The data storage section 328 may also store data corresponding to one or more instructions in the instructions section 324. For example, if the instructions section 324 includes speech recognition or speech generation instructions, the data storage section 328 may comprise a library of sounds or words that may be accessed for the purpose of speech recognition or generation. The data storage section 328 may also store graphics or animations for display on the LCD screens 112, sounds for playback by the speaker 132; and any other data needed for proper execution of the instructions in the instructions section 324. In some embodiments, the data storage section 328 stores pre-recorded video or audio messages for playback via the LCD screens 112 and/or via the speaker 132. Such pre-recorded video or audio messages may be recorded using the video camera 104 and/or microphone 116 of the interactive observation device 100, or such pre-recorded video or audio messages may be recorded using another device and transmitted to the interactive observation device 100 via the wireless transceiver 308, or via a wired connection using a port 136.

In some embodiments, data from the data storage section 328 may be copied, whether selectively, periodically, or continuously, to the cloud, where it may be kept indefinitely. Such functionality may allow a greater quantity of videos to be stored than would be possible using only the memory 320 within the housing of the interactive observation device 100.

The speaker 132 may be used for playing audible sounds as part of the interactive abilities of the interactive observation device 100. Such sounds may comprise speech (including greetings to persons detected within the field of view of the video camera 104 or via the microphone 116, responses to spoken inquiries received via the microphone 116, responses to spoken commands received via the microphone 116, responses to commands received in any other manner; soothing or comforting speech (if, for example, the interactive observation device 100 detects crying via the microphone 116), and playback of audio received via the wireless transceiver (so that, for example, a parent located remotely from the interactive observation device 100 can talk to a child being observed by the interactive observation device 100 through the speaker 132 of the interactive observation device 100)); music (which may be selectable via a mobile app by a remotely located user, or by a spoken request from a person being observed by the interactive observation device 100, or by some other input, such as a specific number of taps on the head 108 detected by a touch sensor 312, or by detecting “yes” and/or “no” nods or other gestures in video obtained via the video camera 104 while a list of music options is provided via the speaker 132, or while music is being played through the speaker 132); white noise; natural sounds (including, for example, one or more of crickets chirping, ocean waves, rainfall, thunder, flowing water); sounds specific to an animal after which the head 108 is modeled (e.g. hooting if the head 108 is configured to represent an owl; meowing and/or purring if the head 108 is configured to represent a cat); prerecorded sounds (e.g. where the interactive observation device 100 is used to observe a child, a parent may record a verbal expression such as “I love you!” or “Good night”; a bedtime story; or song); or any other desired sounds. The speaker 132 may be any speaker suitable for use in a relatively small electronic device.

In some embodiments, the interactive observation device 100 may be configured to utilize external speakers via a Bluetooth, Wi-Fi, or other wireless connection, whether in addition to or instead of the speaker 132. Alternatively, one or more external speakers may be connected to the interactive observation device 100 via one or more ports 136, and such speakers may also be used in addition to or instead of the speaker 132.

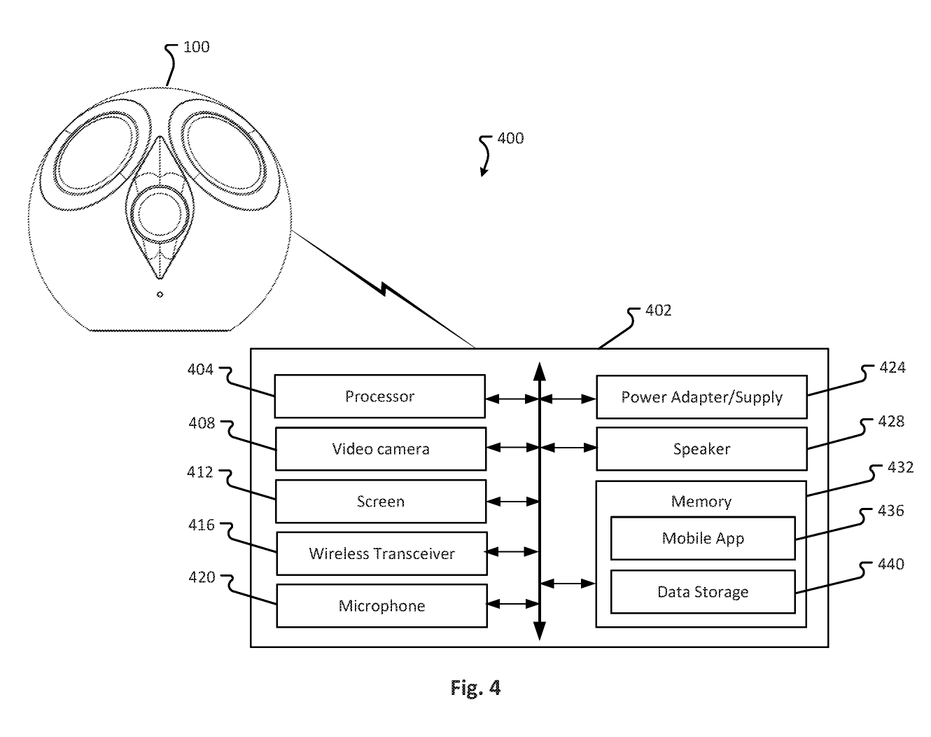

Referring now to FIG. 4 and as already mentioned above, the interactive observation device 100 may be configured to communicate wirelessly with a mobile device 402 in an interactive observation system 400. Such communications may be used both to control the operation of the interactive observation device 100, and to receive data/information (including streaming audio and/or video) from the interactive observation device 100. Thus, in one use scenario, a parent having a mobile device 402 may use the interactive observation device 100 to observe a child while the parent is away from the room (or even the home) in which the child is located. With the mobile device 402, the parent can send commands to the interactive observation device 100, including, for example, commands to rotate the head 108 around the rotatable mount 130, to zoom in on a particular area of the field of view of the video camera 104; to play one or more sounds; and to speak with the child using the microphone 116 and speaker 132 of the interactive observation device 100. The parent can also, in some embodiments, send pictures and or video (including live video) from the mobile device 402 to the interactive observation device 100 for display on one or both of the LCD screens 112. The parent can also receive, at the mobile device, live streaming video from the video camera 104 and live streaming audio from the microphone 116, which may or may not be combined into a single media stream. The parent may receive alerts or alarms from the interactive observation device 100, such as when the interactive observation device 100 detects someone in the room other than the normal occupant(s), or a crying or screaming noise, or an abnormally long period of no motion, or any other predetermined condition.

The mobile device 402 comprises, in some embodiments, a processor 404, a video camera 408, a screen 412, a wireless transceiver 416, a microphone 420, a power adapter/supply 424, a speaker 428, and a memory 432.

The processor 404 may correspond to one or multiple microprocessors that are contained within a housing of the mobile device 402. The processor 404 may comprise a Central Processing Unit (CPU) on a single Integrated Circuit (IC) or a few IC chips. The processor 404 may be a multipurpose, programmable device that accepts digital data as input, processes the digital data according to instructions stored in its internal memory, and provides results as output. The processor 404 may implement sequential digital logic, as it has internal memory. As with most known microprocessors, the processor 404 may operate on numbers and symbols represented in the binary numeral system. The processor 404 may execute instructions stored in a firmware thereof, and may also execute instructions stored in the memory 432. The processor 404 may be used to control one or more aspects of one or more of the video camera 408, the screen 412, the wireless transceiver 416, the microphone 420, the power adapter/supply 424, and the speaker 428. The processor 404 may also be used to read data from or to write data to the memory 432, and may be configured to execute instructions stored within the memory 432.

The video camera 408 is a digital video camera, and may use a CMOS image sensor or a CCD device to capture/record video. The video camera 408 may be or correspond to any video camera suitable for use on mobile devices, including smart phones. The video camera 408 may include a dedicated processor and/or memory, and may comprise various features known to those of skill in the art, including, for example, optical zoom, digital zoom, autofocus, vignetting, optical aberration correction, and optical image stabilization. These features may be provided as part of the video camera 408 itself (e.g. as a set of instructions stored in dedicated memory of the video camera 408, for execution by a dedicated processor of the video camera 408), in instructions stored in the memory 432 and used to operate the video camera 408, or in any other set of instructions available to the processor 304 or to a dedicated video camera processor. The camera may be manufactured, for example and without limitation, by any one of Toshiba Corp., ST Microelectronics N.V., Sharp Corp., Omnivision Technologies, Inc., ON Semiconductor, and Sony Semiconductor Solutions Corporation. In some embodiments, the video camera 408 may utilize the Sony STARVIS image sensor (also known as a starlight image sensor), or any other image sensor designed to capture detailed images in low light conditions.

The screen 412 may be used to display data, including without limitation text and images, to a user of the mobile device 402. The screen 412, which may be an LCD screen, an LED screen, an OLED screen, an AMOLED screen, a Super AMOLED screen, a TFT screen, an IPS screen, a TFT-LCD screen, or any other known variety of screen, may be a touchscreen, and may be used to present virtual buttons or other controls to a user for control of the mobile device 402. The screen 412 may also be used as a viewfinder for the video camera 408, and as a display screen for streaming video received via the wireless transceiver 416.

The wireless transceiver 416 may comprise one or more of a Bluetooth interface, a Wi-Fi card, a Network Interface Card (NIC), a cellular interface (e.g., antenna, filters, and associated circuitry), a near field communication (NFC) interface, a ZigBee interface, a FeliCa interface, a MiWi interface, a Bluetooth low energy (BLE) interface, or the like. Regardless of the protocol used by the wireless transceiver 416, the wireless transceiver 416 may comprise, for example, a transmitter, a receiver, and an antenna, and may also comprise software or firmware needed to operate such components. The wireless transceiver 416 may be used, for example, to establish a connection between the mobile device and the Internet, whether via a cell tower, a router, a hotspot, or otherwise. As shown in FIG. 4, the wireless transceiver may be used to establish a direct connection with the interactive observation device 100, which connection may be a Bluetooth connection, a WiFi connection, or any other type of connection. In other embodiments, the wireless transceiver may be used to send and receive communications to/from the interactive observation device 100 via a wide area network (such as the Internet) or via a local area network.

The microphone or other audio transducer 420 may be useful, for example, to capture sound when recording a video or making a voice or video call. The microphone 420 may be any microphone 420 suitable for use on mobile devices, including smart phones, for example.

The power adapter/supply 424 comprises one or more batteries for powering the various components of the mobile device 402, as well as circuitry for accomplishing any signal transformation, conversion or conditioning needed to provide an appropriate power signal to the components of the mobile device 402. In some embodiments, the power adapter/supply also comprises circuitry for receiving power from an external source, for example to recharge the battery or to power the components of the mobile device 402 when the battery is unable to do so. Such an external power source may be connected to the power adapter/supply 420, for example, via a dedicated power port of the power adapter/supply 424.

The speaker 428 may be any speaker suitable for use in a mobile device, including smart phones. The speaker 428 is used for converting electrical signals into sound waves, and may be useful, for example, for playback of audio from a live or recorded video being displayed on the screen 412, and/or for playback of received audio during a voice or video call. The speaker 428 may be located within a housing of the mobile device 402, or the speaker 428 may be external to the mobile device 402 and connected to the mobile device 402 via a wired or wireless connection.

The memory 432 may comprise a mobile app 436 and a data storage section 440. The memory 432 may correspond to any type of non-transitory computer-readable medium. In some embodiments, the memory 432 may comprise volatile or non-volatile memory and a controller for the same. Non-limiting examples of memory 432 that may be utilized in the mobile device 402 include RAM, ROM, buffer memory, flash memory, solid-state memory, or variants thereof.

The mobile app 436 is described in greater detail with respect to FIG. 5, but generally speaking comprises instructions for execution by the processor 404 that are useful for communicating with and controlling the interactive observation device 100.

The data storage section 440 may be used to store any data needed for operation of the mobile device 402, as well as, in some embodiments, data received via the wireless transceiver 416. Such data may comprise, but are not limited to, video recordings, audio recordings, and event logs.

FIG. 5 depicts a block diagram of a mobile device app 500, which may comprise, by way of example but not limitation, a camera control module 504, an image storage module 508, a viewer module 512, a call module 516, and a settings module 520. The mobile device app 500 may be stored on any mobile device 402, including a smart phone, tablet, or laptop computer. Additionally, the present disclosure encompasses the use of any other software besides a mobile device app, running on any computing device including non-mobile devices, to provide some or all of the features and functionality described herein.

The purpose of the mobile device app 500 is to facilitate use of the interactive observation device 100. The mobile device app 500 accomplishes such communications using the wireless transceiver 416 of the mobile device 402, or, in other embodiments, using any suitable wired or wireless connection with the interactive observation device 100.

The camera control module 504 comprises instructions for controlling the camera of the interactive observation device 100. Such instructions may enable a user of the mobile device 402 to digitally tilt, pan, or zoom within the field of view of the video camera 104, and may also enable the user to cause the head 108 to rotate about the rotatable mount 130 so as to point the video camera 104 in a different direction.

The image storage module 508 comprises instructions for receiving and storing recorded video from the interactive observation device 100. Additionally, the image storage module 508 may comprise functionality allowing a user of the mobile device 402 to capture screen shots of streaming or recorded videos from the interactive observation device 100, and to store such screen shots within the memory 432 of the mobile device 402.

The viewer module 512 comprises instructions that enable the user of the mobile device 402 to watch recorded or streaming video, or to view images, from the interactive observation device 100 on the screen 412 of the mobile device 402. Whether through the camera control module 504 or the viewer module 512, a user may select whether to view some or all of the image captured by the video camera 104 with its 210-degree fisheye lens. When the user elects to view less than all of the image, the viewer module 512 may also comprise instructions for allowing the user to scroll to different parts of the image.

The viewer module 512 may also comprise instructions for adjusting displayed images received from the interactive observation device 100 to remove distortions resulting from the use of the 210-degree fisheye lens, so that displayed images have an appearance (or at least more of an appearance) of having been taking with a regular lens rather than with a fisheye lens.

The call module 516 comprises instructions that enable the user to make and receive voice and video calls with the interactive observation device 100. For voice calls, the call module 516 uses the microphone 420 and speaker 428 of the mobile device 402. For video calls, the call module 516 additionally uses the video camera 408 and the screen 412 of the mobile device 402. Similarly, the interactive observation device 100 uses the microphone 116 and the speaker 132 for voice calls with the mobile device 402, and uses one or both of the LCD screens 112 as well as the video camera 104 for video calls with the mobile device 402. Although the term “call” is used to describe voice and video communications between the mobile device 402 and the interactive observation device 100, such communications may not and need not utilize traditional “calling” networks, such as the plain old telephone system (POTS) network or a cellular network. Rather, such communications may be transmitted over the Internet or another wide area network, or over a local area network or a point-to-point connection, and may occur without first establishing a “call” through traditional dialing, ringing, and answering operations.

The settings module 520 comprises instructions for adjusting the settings of the interactive observation device 100. Such settings may include, for example, which of a plurality of eye designs, images, or animations to display on the LCD screens 112; a brightness control for the LCD screens 112; a volume control for the speaker 132; one or more options regarding how the interactive observation device 100 will respond to one or more sensor inputs (e.g. what sound to play when the interactive observation device is touched); and how long after the most recent activity (which may include a motion detection event, an interaction event, or any other activity) the interactive observation device 100 will remain in a fully powered “awake” mode before entering a low power “sleep” mode. These are only a few examples of many possible settings of the interactive observation device 100, most or all of which may be configurable from the mobile device 402. The settings module 520 may also comprise instructions for accessing the memory 320 of the interactive observation device 100 from the mobile device 402, for example to retrieve stored data from the memory 320, to store additional data on the memory 320, to view files stored in the memory 320, or to otherwise view or modify the contents of the memory 320.

The voice messages module 524 allows a user of the mobile app to interact with the interactive observation device 100 in a number of ways. As one example, the voice messages module 524 may comprise instructions configured to cause the processor to record an audio message, using a microphone of the mobile device on which the mobile device app 500 is running. The audio message may be, for example, a greeting (“Good morning!”), a farewell (“Good night” or “I love you!”), a bedtime story, or a song. The mobile app may then cause the message to be transmitted to the interactive observation device 100 for playback via the speaker 132. In some embodiments, the voice messages module 524 may comprise instructions allowing the user to select when such an audio message will be played over the speaker 132 of the interactive observation device 100. For example, the user may select to play the verbal message immediately, or at or near a child's bedtime, or at or near a child's wake-up time. In some embodiments, one or more stories or other prerecorded audio messages may be stored in a memory 320 of the interactive observation device 100, or in a memory 432 of a mobile device 402, and the voice messages module 524 (or another module of the mobile device app 500) may comprise instructions for execution by the processor that allow a user to of the mobile device app 500 to cause playback of one or more of the prerecorded audio messages at a time, or according to a schedule, of the user's choosing.

In some embodiments, the interactive observation device 100 comprises instructions stored in the memory 320 that are configured to cause the processor to distort or otherwise modify audio signals or messages containing speech and received from the mobile device app 500, or stored in the memory 320 of the interactive observation device 100, so that upon playback the speech contained in the audio signals or messages is in a “voice” of the interactive observation device 100. In some embodiments, the “voice” of the interactive observation device 100 may be selected to sound like a television character or the voice of another well-known personality, or to have one or more features indicative of or corresponding to a living creature represented by the interactive observation device 100.

The mobile app 500 may further comprise a video messages module 528. The video messages module 528 may comprise instructions for recording a video clip with a video camera on or connected to the mobile device 402, and for sending the video clip to the interactive observation device 100. The instructions may further be configured to allow the user of the mobile app 500 to determine when the interactive observation device 100 will play back such video clips, including immediately, at a predetermined time, or according to a predetermined schedule (e.g. every night at bedtime). The video clips may be played back on one or more of the LCD screens 112, or, in embodiments where the interactive observation device 100 comprises a miniprojector, the video clips may be projected by the miniprojector on a wall, ceiling, or other flat service for playback.

The mobile app 500 may yet further comprise an interaction control module 532. The interaction control module 532 may comprise instructions configured to allow a user of the mobile app 500 to cause the interactive observation device 100 to execute one of a plurality of pre-programmed functions. The pre-programmed functions, which may be stored in the memory 320 of the interactive observation device or in the memory 432 of the mobile device 402, may comprise one or more visual expressions to be displayed on the LCD screens 112, one or more sounds to be played over the speaker 132, one or more movements of the head 108, and/or any combination thereof. For example, in some embodiments the interaction control module 532 may allow a user of the mobile app 500 to control one or more emotions displayed by the interactive observation device 100 (e.g. through the images and/or animations displayed on the LCD screens 112, and/or through one or more sounds play through the speaker 132).

One or more of the camera control module 504, the image storage module 508, the viewer module 512, the call module 516, the settings module 520, the voice messages module 524, the video messages module 528, and the interaction control module 532 may, in some embodiments, be provided as part of a single module. In other embodiments, one or more features of any one of the camera control module 504, the image storage module 508, the viewer module 512, the call module 516, the settings module 520, the voice messages module 524, the video messages module 528, and the interaction control module 532 may be provided in an additional, separate module or in a different module than the module with respect to which the one or more features were described herein.

In some embodiments, the mobile device app 500 and/or the interactive observation device 100 may be configured to communicate with and/or utilize third-party services, such as Amazon.com, Inc.'s Alexa (which may provide, for example, voice recognition and speech generation capabilities, as noted in greater detail elsewhere herein, and which may also be used to control one or more aspects of the interactive observation device 100) and Danale Inc.'s cloud service (which may allow users to store videos in the cloud as they are recorded by the video camera 104, for example).

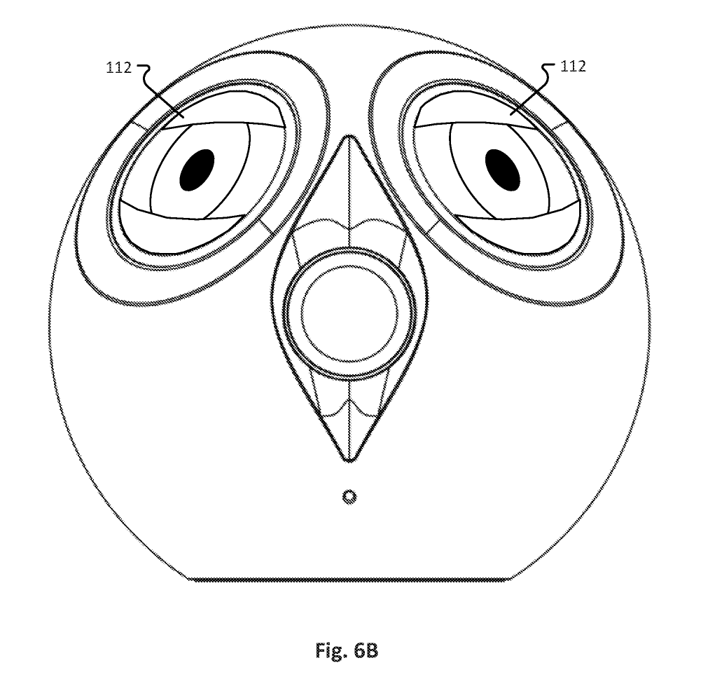

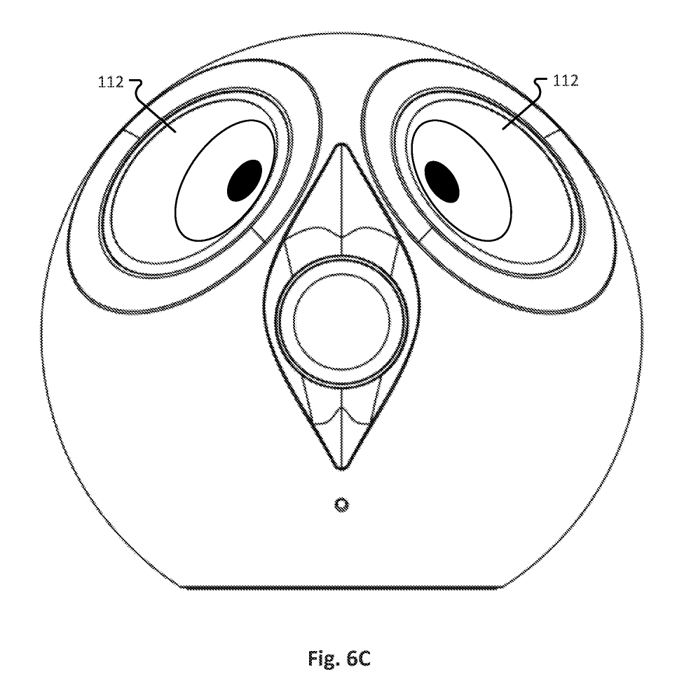

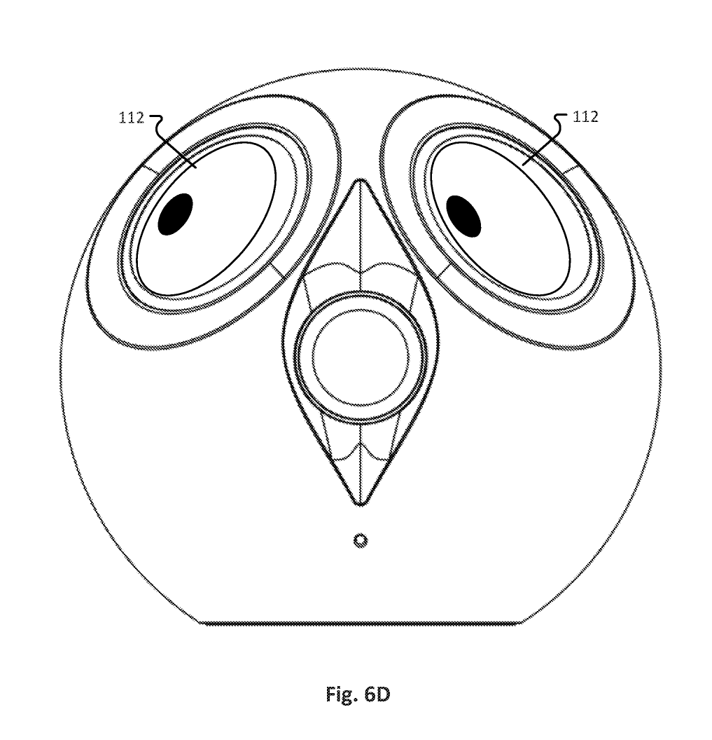

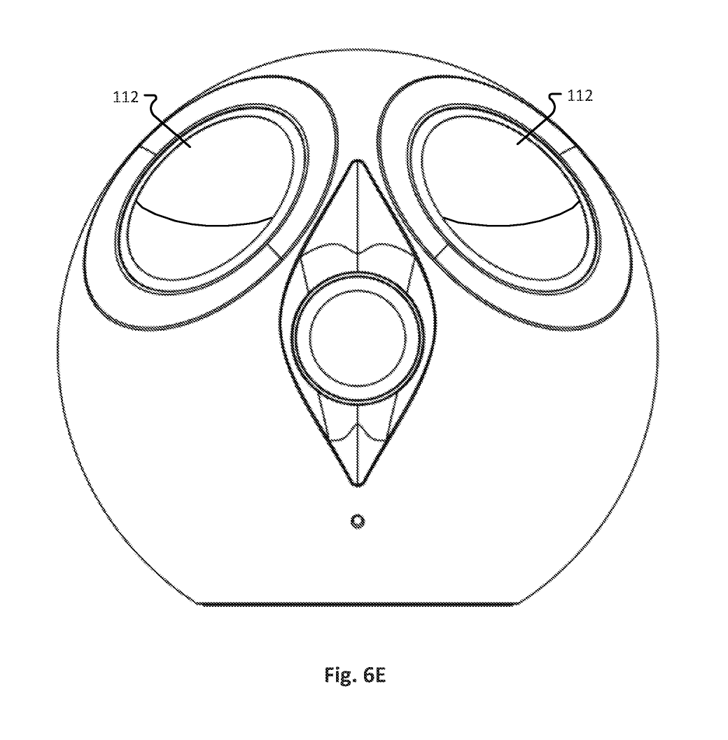

FIGS. 6A through 6E illustrate different eye configurations that may be displayed on the LCD screens 112 of the interactive observation device 100. In FIG. 6A, the screens 112 display narrowed eyes. Such eyes may be displayed, for example, in response to the detection of an unrecognized person within the field of a view of the video camera 104, or in response to shouting detected via the microphone 116, or when a person or object being observed is far away from the camera 104.

In FIG. 6B, the screens 112 display eyes having a normal appearance. Such eyes may be displayed when the interactive observation device 100 is interacting normally with a person, or when the interactive observation device 100 is in an “awake” state but is not presently engaging in any interactions.

In FIG. 6C, the screens 112 display wide open, cross-eyed eyes. Such eyes may be displayed when the interactive observation device 100 is interacting with or observing a person who is very close to the interactive observation device 100, or to demonstrate simulated fear or concern.

FIG. 6D shows the screens 112 displaying eyes that are both pointed in the same direction. Such eyes may be displayed when the interactive observation device 100 is tracking or interacting with a person or object that is within the field of view of the video camera 104, but that is off center to the same side as the side to which the eyes are pointing. In some embodiments, the screens 112 may display eyes that move together back and forth from one side to the other, to suggest or indicate that the interactive observation device 100 is attempting to locate a person or object within the field of view of the video camera 104. Also in some embodiments, such eye movements may be coupled with rotations of the head 108 about the rotatable mount 130, whether to make the interactive observation device 100 look more alive or to enhance the ability of the interactive observation device 100 to locate a person or object within a space being observed or monitored by the interactive observation device 100.

FIG. 6E depicts the screens 112 displaying eyes that are closed. Such eyes may be displayed when the interactive observation device 100 is in a low-power “sleep” mode, or when low light is detected through a light sensor 312.

In some embodiments, the interactive observation device 100 may be configured to interact with a person by playing games such as “peek-a-boo,” where the screens 112 display closed eyes as shown in FIG. 6E, and then simultaneously switch to displaying open eyes while “peek-a-boo” or some other sound plays on the speaker 132 of the interactive observation device 100.

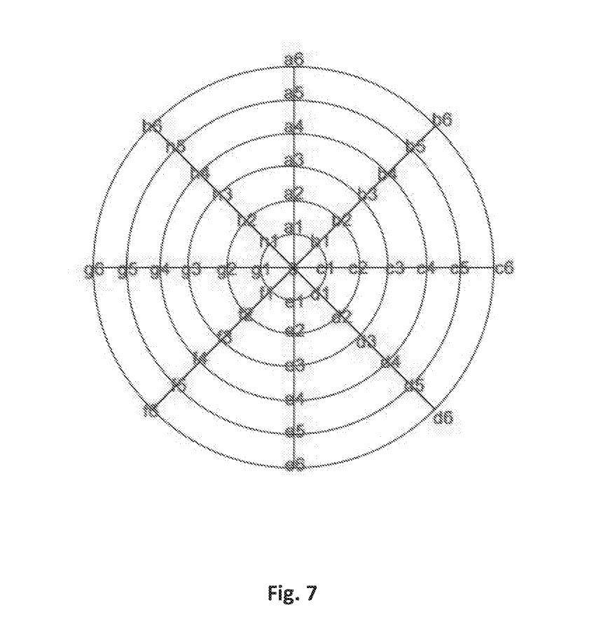

The eye images and animations displayed on the screens 112 are controlled by the processor 104, executing instructions stored in the memory 320 (including instructions stored in the instructions section 324). To properly animate the eyes, the processor 104 detects a person or object within the field of view of the video camera 104, and determines the coordinates of the person or object within field of view of the video camera 104. This determination may be made using an image captured by the video camera 104 and stored in the memory 320, or it may be made using a live image. In some embodiments, the processor may use a grid such as that shown in FIG. 7 to determine the coordinates of the person or object within the image.

After determining the coordinates of the person or object in question, the processor 104 loads an animated eye image (which may have been selected by a user from among a plurality of animated eye images, through a mobile app 500 or otherwise) from memory, and uses the coordinates of the person or object in question to control the animation so that the eyes will be pointed toward the person or object. The processor 104 then causes a video signal corresponding to the properly controlled animation to be sent to the LCD screens 112, where the eye animation is displayed and results in the appearance of the displayed eyes looking at the person or object in question. This process may be repeated on a set interval, or whenever motion is detected using a motion sensor 312, or as a result of some other trigger, to ensure that the displayed eyes remain pointed at the person or object in question even if that person or object moves.

Many additional features and variations of the foregoing description are within the scope of the present disclosure. For example, although not depicted in the figures, an interactive observation device 100 may comprise a base or body to which the head 108 is mounted. In such embodiments, the base or body may comprise one or more components of the interactive observation device 100, and may also be used to provide, for example, increased processing power, more and/or better speakers 132, microphones 116, or sensors 312, more data storage space (e.g. memory); and/or a battery or other backup or primary power source. In such embodiments, the base or body may or may not be shaped and/or designed to look like the body of the same living creature represented by the head 108. Also in such embodiments, one or more sensors 312 may be included in the base or body as well. For example, if the interactive observation device 100 is designed or shaped to represent a dog, then one or more touch sensors may be included on the base or body to detect when the base or body of the dog is being petted.

In some embodiments, the interactive observation device 100 may also include safety sensors, including smoke detection sensors and carbon monoxide sensors. In such embodiments, the interactive observation device 100 may be configured to transmit an alert or alarm via the wireless transceiver 308, in addition to playing an alert or alarm via the speaker 132.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJS™ processors. A processor as disclosed herein may perform computational functions using any known or future-developed standard, instruction set, libraries, and/or architecture.

I claim:

1. An interactive observation device, comprising:
a semi-ellipsoidal housing, the housing comprising:
a plurality of screens on or near an outer surface of the housing;
a video camera comprising a 210-degree fisheye lens;
a microphone;
a speaker;
a wireless transceiver;
a processor; and
a memory, the memory storing instructions for execution by the processor that, when executed by the processor, cause the processor to:
identify, within an image captured by the video camera, a person or object;
determine coordinates of the person or object in the captured image;
modify an eye image stored in the memory based on the coordinates; and
cause the modified eye image to be displayed on at least one of the plurality of screens.

2. The interactive observation device of claim 1, further comprising at least one of a light sensor, a motion sensor, and a proximity sensor.

3. The interactive observation device of claim 2, wherein the memory stores additional instructions for execution by the processor that, when executed by the processor, cause the processor to further modify the eye image based on information received from the at least one of the light sensor, the motion sensor, and the proximity sensor.

4. The interactive observation device of claim 1, further comprising a touch sensor that allows the processor to determine when the housing is being touched and to distinguish between a first type of touch and a second type of touch.

5. The interactive observation device of claim 4, wherein the first type of touch is tapping and the second type of touch is petting.

6. The interactive observation device of claim 1, wherein the memory further stores a plurality of sounds, and the memory stores additional instructions for execution by the processor that, when executed by the processor, cause the processor to:
play one of the plurality of sounds via the speaker based on information received from one of the microphone and the video camera.

7. The interactive observation device of claim 1, wherein the memory stores additional instructions for execution by the processor that, when executed by the processor, cause the processor to stream a live video feed from the video camera via the wireless transceiver.

8. The interactive observation device of claim 7, wherein the live video feed is compressed using an H.265 video compression standard.

9. The interactive observation device of claim 1, wherein the memory stores additional instructions for execution by the processor that, when executed by the processor, cause the processor to:
receive an audio signal via the wireless transceiver; and
play the audio signal using the speaker.

10. The interactive observation device of claim 1, wherein the memory stores additional instructions for execution by the processor that, when executed by the processor, cause the processor to:
adjust a color of the eye image based on user input.

11. The interactive observation device of claim 1, wherein the semi-ellipsoidal housing represents a head of a living creature having two eye positions and one nose position, and further wherein one of the plurality of screens is positioned at a first of the two eye positions, another of the plurality of screens is positioned at a second of the two eye positions, and the video camera is positioned at the one nose position.

12. An interactive observation system, comprising:
an interactive observation device comprising:
a head-shaped housing having two eye positions and one nose position;
two screens, each positioned at one of the two eye positions;
a video camera comprising a 210-degree fisheye lens, the video camera positioned at the one nose position;
a first wireless transceiver;
a first processor; and
a first memory, the first memory storing a plurality of eye images for display on the two screens, the first memory further storing instructions for execution by the first processor that, when executed by the first processor, cause the first processor to:
receive a transmit command via the wireless transceiver; and
transmit a live video feed originated by the video camera via the wireless transceiver in response to the transmit command.

13. The interactive observation system of claim 12, further comprising:
a mobile device comprising a second wireless transceiver, a second processor, and a second memory, the second memory storing a mobile app comprising instructions for execution by the second processor that, when executed by the second processor, cause the second processor to:
send a transmit command to the interactive observation device via the second wireless transceiver; and
receive a live video feed from the interactive observation device via the second wireless transceiver.

14. The interactive observation system of claim 13, wherein the interactive observation device further comprises a first microphone and a first speaker mounted within the housing, the mobile device further comprises a second microphone and a second speaker, and wherein the first memory stores additional instructions for execution by the first processor that, when executed by the first processor, cause the first processor to:
receive a first audio signal generated by the first microphone;
transmit the first audio signal, via the first wireless transceiver, to the mobile device;
receive, via the first wireless transceiver, a second audio signal generated by the second microphone; and
route the second audio signal to the first speaker.

15. The interactive observation system of claim 13, wherein the mobile app further comprises instructions for execution by the second processor that, when executed by the second processor, cause the second processor to:
receive user input regarding a setting of the interactive observation device;
generate a command based on the user input; and
transmit the command, via the second wireless transceiver, to the interactive observation device.

16. The interactive observation system of claim 12, wherein the interactive observation device further comprises at least one of a motion sensor, a proximity sensor, and a touch sensor, and further wherein the first memory stores additional instructions for execution by the first processor that, when executed by the first processor, cause the first processor to:
receive data from the at least one of the motion sensor, the proximity sensor, and the touch sensor;
analyze the data;
select an eye image from among the plurality of eye images to be displayed on each of the two screens; and
cause the selected eye images to be displayed on the two screens.

17. The interactive observation system of claim 12, wherein each of the two screens comprises an LCD screen.

18. An interactive device for remote observation, comprising:
a housing;
two display screens for displaying eye animations;
a video camera comprising a 210-degree fisheye lens that is mounted on the housing equidistant from each of the two display screens;
a microphone;
a sensor;
a wireless communication device;
a processor; and
a memory, the memory storing instructions for execution by the processor that, when executed by the processor, cause the processor to:
receive a first input from one of the video camera, the microphone, and the sensor;
based on the first input, cause a first eye animation to be displayed on the two display screens;
receive a second input from one of the video camera, the microphone, and the sensor; and
based on the second input, cause a second eye animation to be displayed on the two display screens.

19. The interactive device for remote observation of claim 18, wherein the second eye animation comprises a modified first eye animation.

20. The interactive device for remote observation of claim 18, wherein the memory stores further instructions for execution by the processor that, when executed by the processor, cause the processor to:
transmit, via the wireless communication device, at least one of a live video feed from the video camera and a live audio feed from the microphone.
